(19) United States
(12) Patent Application Publication
(10) Pub. No.: US 2020/0280647 A1
(43) Pub. Date: Sep. 3, 2020

(54) IMAGE FORMING APPARATUS AND IMAGE FORMING METHOD

(71) Applicant: SHARP KABUSHIKI KAISHA, Sakai City (JP)

(72) Inventor: SHOJI NODA, Sakai City (JP)

(21) Appl. No.: 16/802,134

(22) Filed: Feb. 26, 2020

(30) Foreign Application Priority Data
Feb. 28, 2019 (JP) 2019-035922

(51) Int. Cl. H04N 1/00

(52) U.S. Cl. CPC H04N 1/00482; H04N 1/00708; H04N 1/00663; H04N 1/00395

(57) ABSTRACT

Provided is an image forming apparatus including: a sheet feed tray that stores a plurality of kinds of sheet for image formation; a display; an operation device that receives an operation from a user; an image former that forms an image; and a controller that controls the display, the operation device, and the image former. The controller causes the display to selectably display a plurality of prescribed classifications of the sheet, causes the display to selectably display a kind of sheet included in one classification selected though the operation device, and causes the image former to form an image on one kind of sheet selected though the operation device.

### FIELD OF THE INVENTION

The present invention relates to an image forming apparatus and an image forming method.

### DESCRIPTION OF THE BACKGROUND ART

Some image forming apparatuses including a copying machine such as a printer having a copy function and a multifunction peripheral (MFP) additionally having a function other than the copy function, include a sheet feed tray that accommodates sheets different in size and type.

In such image forming apparatuses, a user typically selects a desired size and type of sheet through a sheet setting screen on an operation panel to start printing.

Conventionally, for an example of an invention for such a sheet setting, an invention of a digital multifunctional apparatus is disclosed (see, for example, Japanese Unexamined Patent Application Publication No. 2001-235976) in which, if a sheet selection key is depressed on a standard screen, a “sheet selection” screen is displayed, and information of a sheet (size/type/remaining amount) set in a manual feed tray is displayed.

For another example, an invention of an image forming apparatus is disclosed (see, for example, Japanese Unexamined Patent Application Publication No. 2015-087470). The image forming apparatus includes: a storage that stores sheet type and/or size information of a sheet input via a user operation on a display operation device; and an estimator that estimates a sheet type and/or size of a sheet set in a sheet tray. In the image forming apparatus, if an estimation result of the estimator is different from a sheet type and/or size stored in the storage, a sheet change detector detects that the sheet type and/or size of the sheet set in the sheet tray has changed.

In a conventional invention, if a sheet is set in a sheet feed tray or in a manual feed tray, a setting screen for the sheet size and type corresponding to the tray is displayed on an operation panel, and thus, a setting effort is omitted, which has high usability for a user.

However, in an image forming apparatus including sheet feed trays that store various sizes and types of sheets, if all the sizes and types of sheets stored in the sheet feed trays are displayed on one screen, there is a problem in that the setting screen is often complicated, and, on the contrary, usability for a user deteriorates.

The present invention has been made in consideration of the above circumstances, and an object thereof is to provide: an image forming apparatus capable of displaying a more efficient sheet setting than a conventional sheet setting to reduce the complexity of the sheet setting and enhance usability for a user; and an image forming method therefor.

### SUMMARY OF THE INVENTION

(1) The present invention provides an image forming apparatus including: a sheet feed tray that stores a plurality of kinds of sheet for image formation; a display; an operation device that receives an operation from a user; an image former that forms an image; and a controller that controls the display, the operation device, and the image former, wherein the controller causes the display to selectably display a plurality of prescribed classifications of the sheet, causes the display to selectably display a kind of sheet included in one classification selected though the operation device, and causes the image former to form an image on one kind of sheet selected though the operation device.

Further, the present invention provides a method of forming an image by an image forming apparatus including a sheet feed tray that stores a plurality of kinds of sheet for image formation and an image former that forms an image. The method includes: displaying; receiving an operation from a user; and forming an image, wherein in the displaying, prescribed classifications of the sheet are selectably displayed, a kind of sheet included in one classification selected in the receiving is selectably displayed, and in the forming, an image is formed on one kind of sheet selected in the receiving.

In the present invention, the “image forming apparatus” is an apparatus for forming and outputting an image, including a copying machine such as a printer having a copy function and using an electrophotographic scheme for image formation by a toner and a multifunction peripheral (MFP) additionally having a function other than the copy function.

The “plurality of kinds of sheets for image formation” includes sheets having different sizes such as A4 size and B5 size, sheets having different thickness such as plain paper and thick paper, sheets having different paper quality such as glossy paper and inkjet sheets, and the like.

The “sheet feed tray” is a tray that stores a sheet for image formation, and may be a manual feed tray.

The “prescribed sheet classifications” is, for example, prescribed sheet classifications including “envelope”, “postcard”, and “inch system”.

The “operation device” in the present invention is implemented by an operation panel 16. Further, the “display” in the present invention is implemented by a display operation device 161.

According to the present invention, based on a selection result of a sheet classification selected by the user, a sheet type determined to be displayed is displayed on the setting screen, and thus, it is possible to display a more efficient sheet setting than a conventional sheet setting, reduce the complexity of the sheet setting, and achieve an image forming apparatus having high usability for a user and an image forming method therefor.

Further, preferable aspects of the present invention will be described.

(2) In the image forming apparatus according to the present invention, the sheet classifications may include prescribed sheet type classifications, and if the operation device receives an operation that one of the sheet type classifications is selected, the controller may cause the display to selectably display a kind of sheet included in the one classification selected though the operation device.

The “prescribed sheet type classifications” is, for example, classifications prescribed based on a sheet application, such as “envelope”, “postcard”, and “photo sheet”, or classifications prescribed based on a sheet category such as “thick paper” and “glossy paper”.

Thus, a kind of sheet determined to be displayed based on a selection result of a sheet type selected by the user is displayed on the setting screen, and thus, it is possible to display the more efficient sheet setting than a conventional sheet setting, reduce the complexity of the sheet setting, and achieve an image forming apparatus having high usability for a user.

(3) in the image forming apparatus according to the present invention, the sheet classifications may include prescribed sheet size classifications, and if the operation device receives an operation that one of the sheet size classifications is selected, the controller may cause the display to selectably display a kind of sheet included in the one classification selected though the operation device.

The “prescribed sheet size classifications” is, for example, classifications prescribed based on a sheet size such as a “sheet size based on Japanese standard” or a “sheet size based on European and American standard”, and an “envelope size”.

Thus, a kind of sheet determined to be displayed based on a selection result of a sheet size selected by the user is displayed on the setting screen, and thus, it is possible to display the more efficient sheet setting than a conventional sheet setting, reduce the complexity of the sheet setting, and achieve an image forming apparatus having high usability for a user.

(4) In the image forming apparatus according to the present invention, a sheet detection sensor that detects whether a sheet is stored in the sheet feed tray may be further provided, and if the sheet detection sensor detects a sheet stored in the sheet feed tray, the controller may cause the display to selectably display a kind of sheet that can be accommodated in the sheet feed tray.

Thus, a kind of sheet determined to be displayed based on the kind of sheet that can be stored in the sheet feed tray is displayed on the setting screen, and thus, it is possible to display the more efficient sheet setting than a conventional sheet setting, reduce the complexity of the sheet setting, and achieve an image forming apparatus having high usability for a user.

(5) in the image forming apparatus according to the present invention, a sheet size detection sensor that detects a size of a sheet stored in the sheet feed tray may be further provided, and the controller may cause the display to selectably display a kind of sheet determined to be displayed based on a sheet size detected by the sheet size detection sensor.

Thus, a kind of sheet determined to be displayed based on a detection result of a size of a sheet stored in the sheet feed tray is displayed on the setting screen, and thus, it is possible to display the more efficient sheet setting than a conventional sheet setting, reduce the complexity of the sheet setting, and achieve an image forming apparatus having high usability for a user.

(6) in the image forming apparatus according to the present invention, the controller may cause the display to selectably display, in accordance with a prescribed priority order, a kind of sheet determined to be displayed based on a selection result of the sheet classifications received through the operation device.

Thus, a kind of sheet determined to be displayed based on a selection result of the sheet classifications selected by the user is rearranged in accordance with the prescribed priority order and displayed on the setting screen, and thus, it is possible to display the more efficient sheet setting than a conventional sheet setting, reduce the complexity of the sheet setting, and achieve an image forming apparatus having high usability for a user.

(7) In the image forming apparatus according; to the present invention, the sheet feed tray may store an envelope or a postcard.

Thus, in the image forming apparatus including a sheet feed tray that stores an envelope or a postcard, a kind of sheet determined to be displayed based on a selection result of the sheet classifications selected by the user is displayed on a setting screen, and thus, it is possible to display a more efficient sheet setting than a conventional sheet setting, reduce the complexity of the sheet setting, and achieve an image forming apparatus having high usability for a user.

### BRIEF DESCRIPTION OF THE DRAWINGS

FIG. 1 is a perspective view illustrating an external appearance of a digital multifunctional apparatus according to a first embodiment of the present invention;

FIG. 2 is a plan view of the digital multifunctional apparatus in FIG. 1;

FIG. 3 is an explanatory diagram illustrating a panel unit of the digital multifunctional apparatus in FIG. 1;

FIG. 4 is a block diagram illustrating a simplified configuration of the digital multifunctional apparatus in FIG. 1;

FIG. 5 is a flowchart illustrating an outline of a sheet setting process by the digital multifunctional apparatus in FIG. 1;

FIG. 6 is an explanatory diagram illustrating an example of a setting screen displayed on a display operation device of the digital multifunctional apparatus in FIG. 1;

FIG. 7 is an explanatory diagram illustrating an example of the setting screen displayed on the display operation device of the digital multifunctional apparatus in FIG. 1;

FIG. 8 is an explanatory diagram illustrating an example of the setting screen displayed on the display operation device of the digital multifunctional apparatus in FIG. 1;

FIG. 9 is an explanatory diagram illustrating an example of the setting screen displayed on the display operation device of the digital multifunctional apparatus in FIG. 1;

FIG. 10 is an explanatory diagram illustrating an example of a setting screen displayed on a display operation device of a conventional digital multifunctional apparatus;

FIG. 11 is an explanatory diagram illustrating an example of the setting screen displayed on the display operation device of the conventional digital multifunctional apparatus;

FIG. 12 is a block diagram illustrating a simplified configuration of a digital multifunctional apparatus according to a second embodiment of the present invention;

FIG. 13 is a flowchart illustrating an outline of a sheet setting process by the digital multifunctional apparatus in FIG. 12;

FIG. 14 is an explanatory diagram illustrating an example of a setting screen displayed on a display operation device of the digital multifunctional apparatus in FIG. 12; and

FIG. 15 is an explanatory diagram illustrating an example of the setting screen displayed on the display operation device of the digital multifunctional apparatus in FIG. 12.

### DESCRIPTION OF THE PREFERRED EMBODIMENTS

The present invention will be described below in more detail with reference to the drawings. It is noted that the following description is an exemplified illustration in all aspects and should not be interpreted to limit the present invention.

### First Embodiment

### Simplified Configuration of Digital Multifunctional Apparatus 1

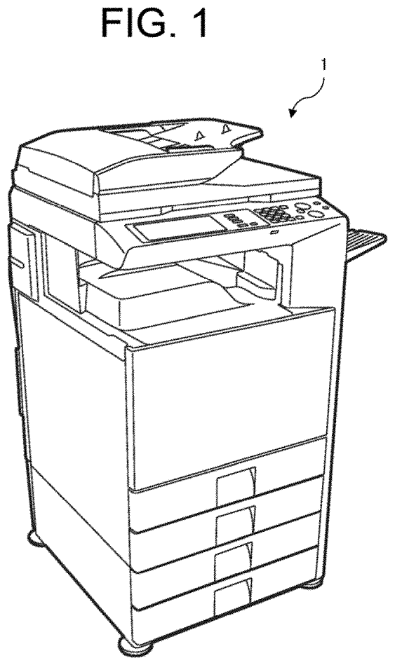

A digital multifunctional apparatus 1 according to a first embodiment of the present invention will be described with reference to FIGS. 1 to 4.

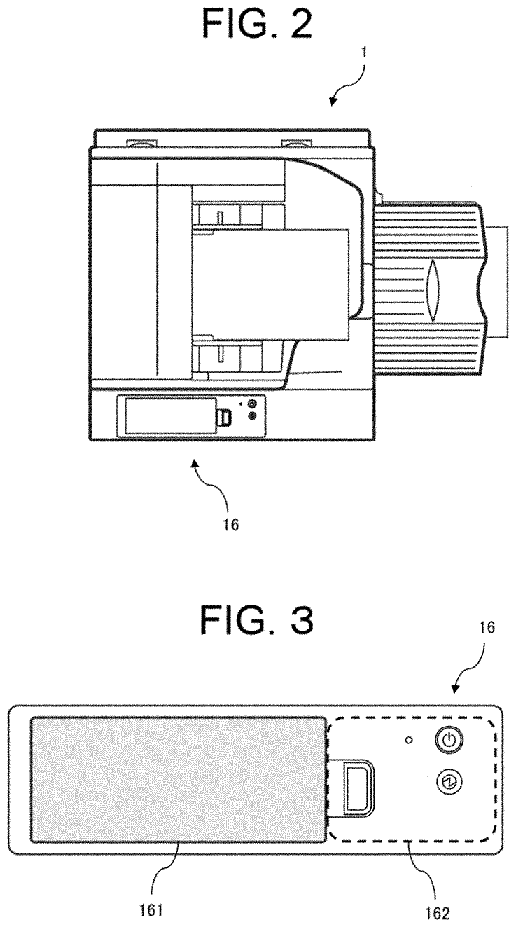

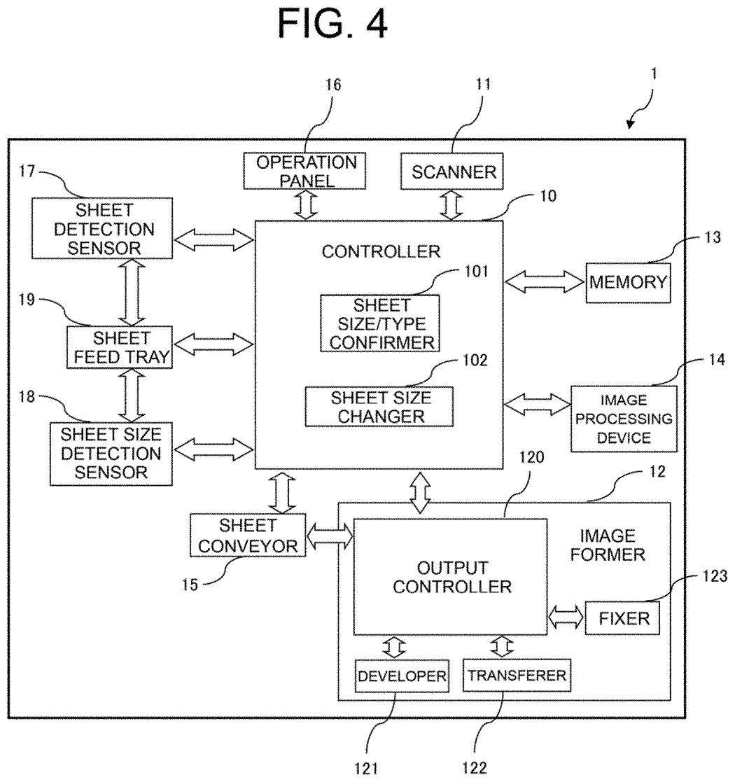

FIG. 1 is a perspective view illustrating an external appearance of the digital multifunctional apparatus 1 according to the first embodiment of the present invention. FIG. 2 is a plan view of the digital multifunctional apparatus 1 in FIG. 1. FIG. 3 is an explanatory diagram illustrating an operation panel 16 of the digital multifunctional apparatus 1 in FIG. 1. FIG. 4 is a block diagram illustrating a simplified configuration of the digital multifunctional apparatus 1 in FIG. 1.

The digital multifunctional apparatus 1 according to the first embodiment of the present invention is an apparatus for digitally processing image data, such as a multifunction peripheral (MFP) having a copy function, a scanner function, and a facsimile function.

The digital multifunctional apparatus 1 executes a job such as scanning, printing, copying, or image transmission, based on a user instruction received via a display operation device 161 or a physical operation device 162.

Next, a simplified configuration of the digital multifunctional apparatus 1 will be described with reference to FIG. 4.

As illustrated in FIG. 4, the digital multifunctional apparatus 1 includes a controller 10, a scanner 11, an image former 12, a memory 13, an image processing device 14, a sheet conveyor 15, the operation panel 16, a sheet detection sensor 17, a sheet size detection sensor 18, and a sheet feed tray 19.

Constitution elements of the digital multifunctional apparatus 1 will be described below.

The controller 10 integrally controls the digital multifunctional apparatus 1, and includes a CPU, a RAM, a ROM, various types of interface circuits, and the like.

The controller 10 monitors and controls detection by each of the sensors, and any load such as a motor, a clutch, and the operation panel 16 to control an operation of the entire digital multifunctional apparatus 1.

The scanner 11 detects and reads a document placed on a document platen and generates image data.

The image former 12 forms and outputs an image onto a sheet, based on the image data acquired by the scanner 11, and includes an output controller 120, a developer 121, a transferer 122, and a fixer 123.

The output controller 120 controls the developer 121, the transferer 122, and the fixer 123 to perform output control for copying, or the like.

The developer 121 supplies toner to an electrostatic latent image formed on a photoconductive drum charged to a predetermined potential by a charger to visualize the electrostatic latent image.

The transferer 122 transfers a toner image formed on a surface of the photoconductive drum onto a sheet conveyed by the sheet conveyor 15.

The fixer 123 fixes the image by pressing and heating the sheet onto which the image has been transferred by the transferer 122.

The memory 13 is an element or a storage medium that stores information, a control program, and the like necessary for realizing various functions of the digital multifunctional apparatus 1. For example, a semiconductor element such as a RAM or a ROM, or a storage medium such as a hard disk, a flash storage, and an SSD is employed for the memory 13.

It is noted that a program and data may be stored in different devices, for example, so that a region where the data is stored is included in a hard disk drive and a region where the program is stored is included in a flash storage.

The image processing device 14 converts a document image read by the scanner 11 into an appropriate electric signal to generate image data, and processes the image data input from the scanner 11 to output the image data in an enlarged or contracted manner, in accordance with a command from the display operation device 161.

The sheet conveyor 15 conveys a sheet stored in a sheet feed cassette or in a manual feed tray to the image former 12 via a predetermined convey path. Further, the sheet conveyor 15 discharges the sheet onto which the image is formed by the image former 12 to a sheet discharge tray via a predetermined convey path.

The operation panel 16 includes a liquid crystal display, and includes the display operation device 161 and the physical operation device 162.

The display operation device 161 displays various types of information. The display operation device 161 includes, for example, a CRT display, a liquid crystal display, and an EL display, and is a display device such as a monitor or a line display on which an operating system or an application software display electronic data such as a processing state. The controller 10 displays an operation and a state of the digital multifunctional apparatus 1 via the display operation device 161.

Further, the display operation device 161 includes a touch panel and receives a command from a user.

The physical operation device 162 includes an OK key and a power key.

The sheet detection sensor 17 detects whether a document sheet is placed in the sheet feed tray 19 or on the document platen.

Further, the sheet detection sensor 17 can also detect a change of the sheet.

The sheet size detection sensor 18 detects the size of a document sheet placed on the sheet feed tray 19 or the document platen.

The sheet feed tray 19 is a tray such as a sheet feed cassette and a manual feed tray for storing a sheet for image forming.

### Example of Sheet Setting Process of Digital Multifunctional Apparatus 1 According to First Embodiment of the Present Invention

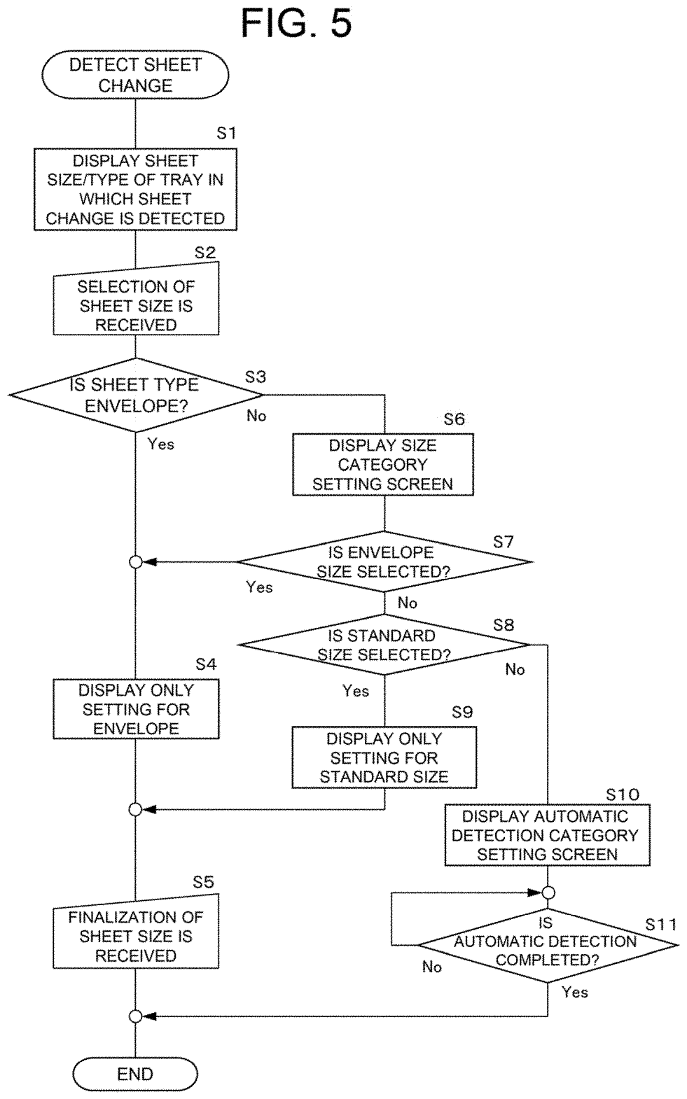

Subsequently, an example of a sheet setting process of the digital multifunctional apparatus 1 according to the first embodiment of the present invention will be described with reference to FIGS. 5 to 11.

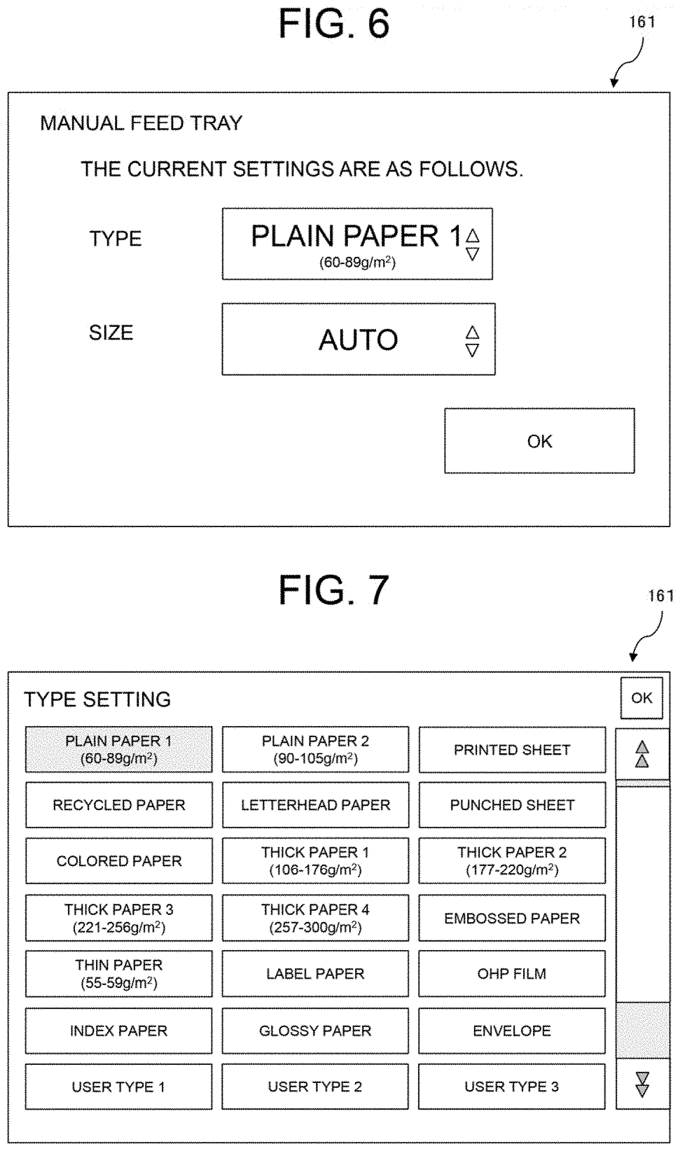

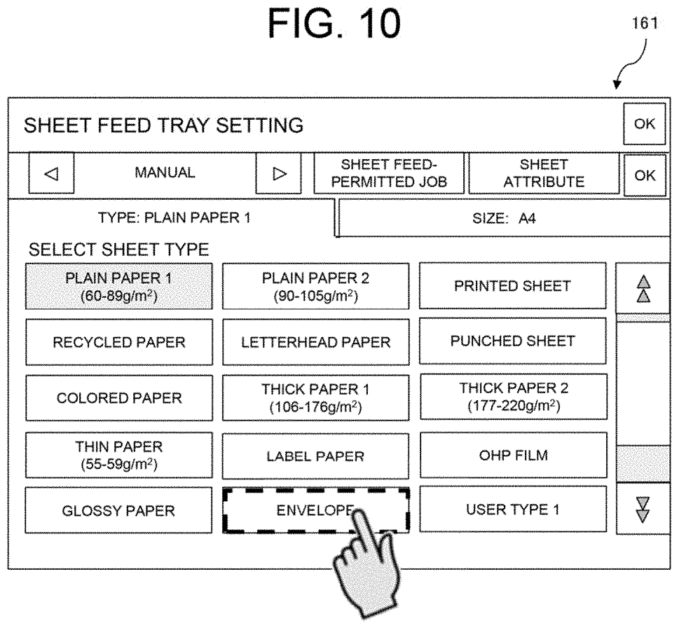

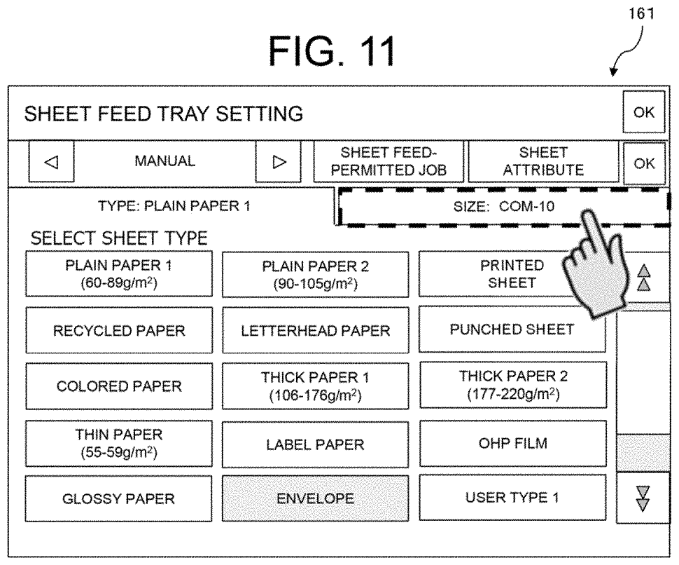

FIG. 5 is a flowchart illustrating; an outline of the sheet setting process by the digital multifunctional apparatus 1 in FIG. 1. FIGS. 6 to 9 are explanatory diagrams illustrating an example of a setting screen displayed on the display operation device 161 of the digital multifunctional apparatus 1 in FIG. 1, FIGS. 10 and 11 are explanatory diagrams illustrating an example of a setting screen displayed on a display operation device 161 of a conventional digital multifunctional apparatus 1.

In FIG. 5, if the sheet detection sensor 17 detects a sheet change, in step S1, the controller 10 displays, on the operation panel 16, all sheet sizes and sheet types applicable to a tray in which the sheet change is detected (step S1).

Here, the “sheet size” is the size of the sheet such as A4 size or B5 size.

Further, the “sheet type” is a sheet category including “envelope”, “postcard”, “plain paper”, “thick paper”, “glossy paper”, and “inkjet sheet”.

FIG. 6 illustrates an example of a setting screen displaying a currently set sheet type “plain paper 1 (60-89 g/m²)” and a size “auto” if the sheet detection sensor 17 detects a sheet in the sheet feed tray.

If a user changes the sheet type or size, the user touches a corresponding button.

In FIG. 6, if the “plain paper 1 (60-89 g/m²)” button is touched, a sheet type setting screen as illustrated in FIG. 7 is displayed on the display operation device 161.

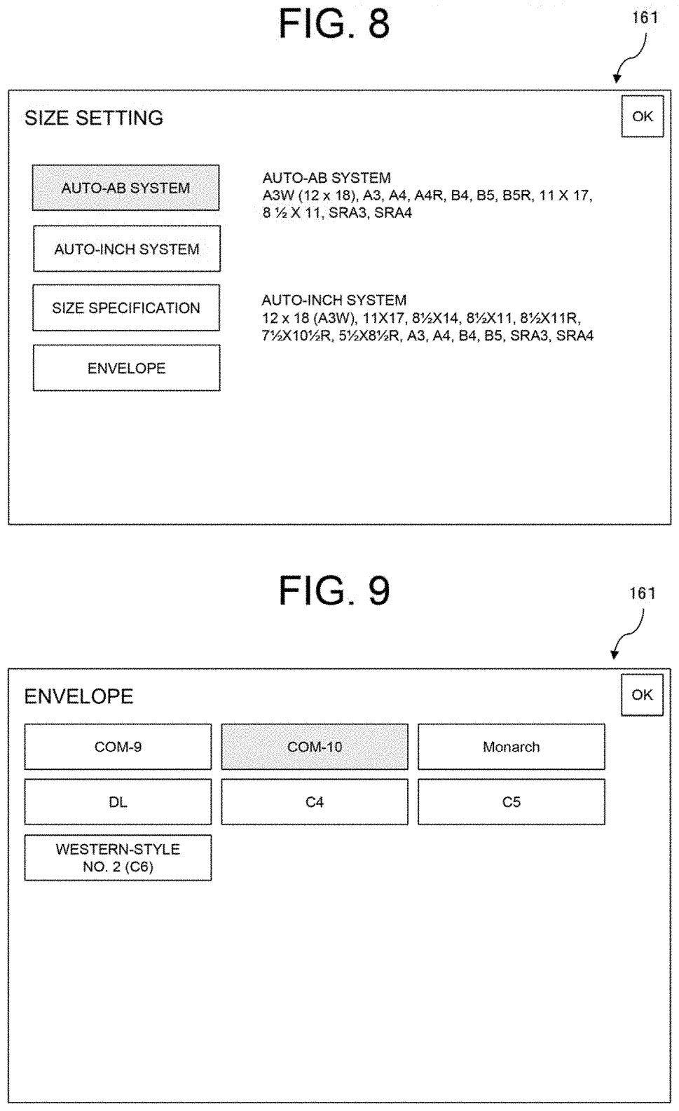

On the other hand, if the “auto” button is touched in FIG. 6, a sheet size setting screen as illustrated in FIG. 8 is displayed on the display operation device 161.

In FIG. 8, four sheet size classifications, “auto-AB series”, “auto-inch system”, “size specification”, and “envelope”, are displayed.

“AB series” is a sheet size classification based on Japanese standard, and “inch system” is a sheet size classification based on European and American standard.

“Size specification” is a classification for a sheet size not automatically detected.

“Envelope” is a classification for a sheet size used for an envelope.

After selecting a desired sheet size classification, the user touches an “OK” button at the upper right of the screen to finalize the selected sheet size classification.

In step S2 of FIG. 5, if the operation panel 16 receives an operation that a sheet size is selected (step S2), the controller 10 determines whether or not the sheet type is an “envelope” type in step S3 (step S3).

If the sheet type is the “envelope” type (if the determination in step S3 is Yes), the controller 10 displays only a setting for the “envelope” on the display operation device 161 in step S4 (step S4).

As illustrated in FIG. 9, only sizes “COM-9”, “COM-10”, “Monarch”, “DL”, “C4”, “C5”, and “Western-style No. 2 (C6)” for the envelope are displayed on the display operation device 161.

On the other hand, in the conventional digital multifunctional apparatus 1, if a user selects an envelope size, as illustrated in FIG. 10, after selecting first the type “envelope” from among many sheet types, the user needs to select “size” to display a list of envelope sizes, as illustrated in FIG. 11, which is burdensome.

Next, in step S5 of FIG. 5, if the display operation device 161 receives the finalization of the selected sheet size (step S5), the controller 10 ends the sheet setting process on the setting screen.

On the other hand, in step S3, if the sheet type is not “envelope” (if the determination in step S3 is No), the controller 10 displays a size category setting screen on the display operation device 161 in step S6 (step S6).

Next, in step S7 of FIG. 5, the controller 10 determines whether or not the display operation device 161 receives an operation that an “envelope” size sheet is selected (step S7).

If the display operation device 161 receives an operation that the “envelope” size sheet is selected (if the determination in step S7 is Yes), the controller 10 displays only a setting for the envelope on the display operation device 161 in step S4 (step S4).

On the other hand, if the display operation device 161 does not receive an operation that the “envelope” size sheet is selected (if the determination in step S7 is No), the controller 10 determines whether or not the display operation device 161 receives an operation that a “standard” size sheet is selected in step S8 (step S8).

If the display operation device 161 receives an operation that the “standard” size sheet is selected (if the determination in step S8 is Yes), the controller 10 displays only a setting for the “standard” size on the display operation device 161 in step S9 (step S9).

Afterwards, the controller 10 performs the process in step S5 (step S5).

On the other hand, if the display operation device 161 does not receive an operation that the “standard” size sheet is selected (if the determination in step S8 is No), the controller 10 displays an automatic detection category setting screen on the display operation device 161 in step S1.0 (step S10).

Subsequently, in step S11, the controller 10 causes the sheet size detection sensor 18 to automatically detect the sheet size, and determines whether or not the automatic detection is completed (step S11).

If the automatic detection is completed (if the determination in step S11 is Yes), the controller 10 ends the sheet setting process on the setting screen.

Thus, an optimal setting screen is displayed based on the automatically detected sheet size and a selection result by the user on the sheet setting screen, and thus, it is possible to perform the sheet setting more efficiently than conventionally, reduce the complexity of the sheet setting, and achieve the digital multifunctional apparatus 1 having high usability for a user.

### Second Embodiment

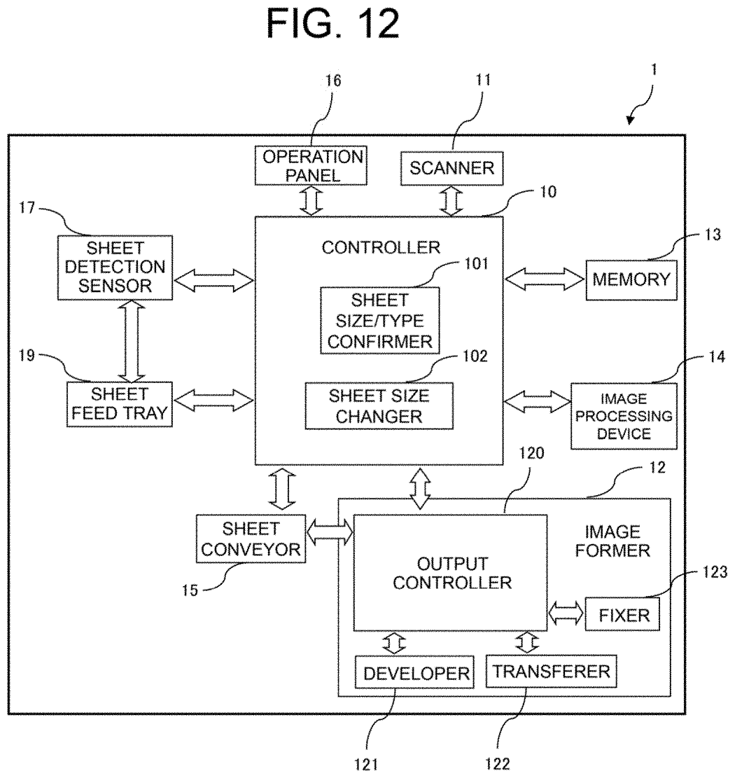

Next, the digital multifunctional apparatus 1 according to a second embodiment of the present invention will be described with reference to FIGS. 12 to 15.

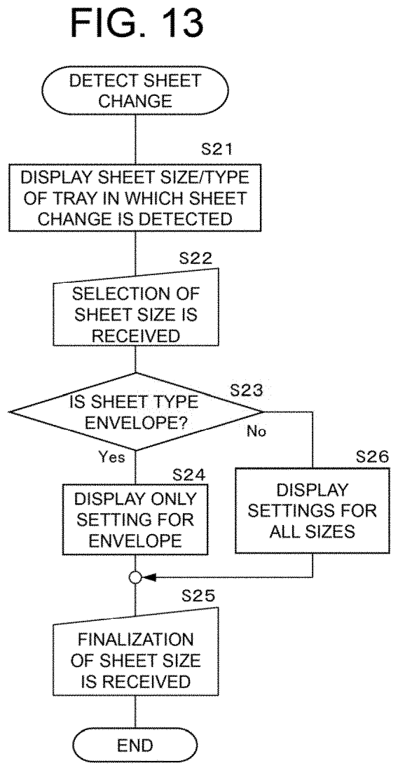

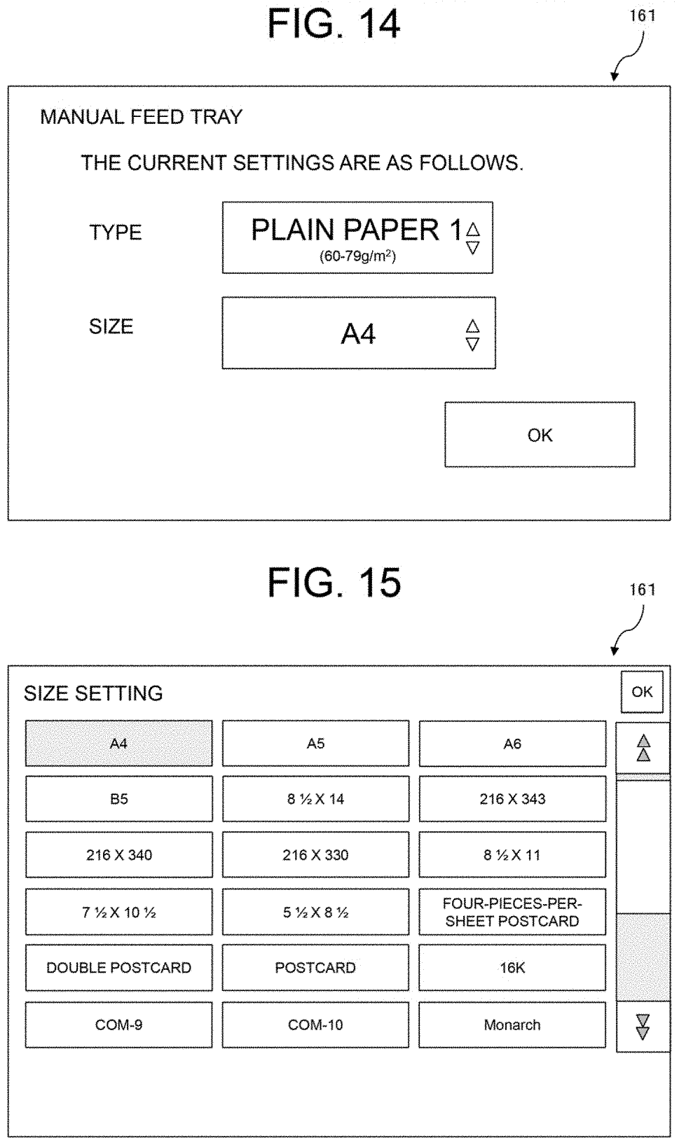

FIG. 12 is a block diagram illustrating a simplified configuration of the digital multifunctional apparatus 1 according to the second embodiment of the present invention. FIG. 13 is a flowchart illustrating an outline of the sheet setting process by the digital multifunctional apparatus 1 in FIG. 12. FIGS. 14 and 15 are explanatory diagrams illustrating an example of the setting screen displayed on the display operation device 161 of the digital multifunctional apparatus 1 in FIG. 12.

As illustrated in FIG. 12, the digital multifunctional apparatus 1 according to the second embodiment is the same as the digital multifunctional apparatus 1 according to the first embodiment, except that the sheet size detection sensor 18 is not provided.

It is noted that steps S21 to S25 in FIG. 13 correspond to steps S1 to S5 in FIG. 5 respectively.

In FIG. 13, if the sheet detection sensor 17 detects a sheet change, the controller 10 displays, on the operation panel 16, all sheet sizes and sheet types applicable to a tray in which the sheet change is detected, in step S21 (step S21).

FIG. 14 illustrates an example of a setting screen displaying a currently set sheet type “plain paper 1 (60-79 g/m²)” and size “A4” if the sheet detection sensor 17 detects a sheet in the sheet feed tray.

If a user changes the sheet type or size, the user touches a corresponding button.

In FIG. 14, if the “A4” button is touched, a sheet type setting screen as illustrated in FIG. 15 is displayed on the display operation device 161.

If the operation panel 16 receives an operation that a sheet size is selected in step S22 in FIG. 13 (step S22), the controller 10 determines whether or not the sheet type is the “envelope” type in step S23 (step S23).

If the sheet type is not the “envelope” type in step S23 in FIG. 13 (if the determination in step S23 is No), the controller 10 displays a setting screen for all sizes on the display operation device 161, in step S26 (step S26).

In FIG. 15, a sheet size setting screen for all the sizes including “A4” and “B5” is displayed.

After selecting a desired sheet size, the user touches the “OK” button at the upper right of the screen to finalize the selected sheet size.

Afterwards, the controller 10 performs the process in step S25 step S25).

On the other hand, if the sheet type is the “envelope” type (if the determination in step S23 is Yes), the controller 10 displays only a setting for the “envelope” on the display operation device 161 in step S24 (step S24).

Afterwards, the controller 10 performs the process in step S25 (step S25).

Compared with the first embodiment, in the second embodiment, the setting of the automatic detection category is not necessary, and thus, the size category is limited if the change of the sheet size is received.

Therefore, a size selection screen listing standard sizes of a sheet which the tray can feed is displayed, without displaying a category setting screen, and thus, the number of steps in the setting change is reduced.

On the other hand, similar to the first embodiment, in a case where the sheet type is set to “envelope”, it is sufficient to display only envelope size options, and thus, setting items are displayed only for the envelope sizes among the standard sizes.

Thus, a setting item unnecessary for an application of a user is not displayed, and further, only a necessary setting screen is displayed based on the selection result by the user on the sheet setting screen, and thus, it is possible to perform the sheet setting more efficiently than conventionally, reduce the complexity of the sheet setting, and achieve the digital multifunctional apparatus 1 having high usability for a user.

### Third Embodiment

In a third embodiment, if the sheet type is “postcard” or “photo”, only a setting for “postcard” or “photo” may be displayed.

An example of the setting for “postcard” or “photo” includes a setting for a predetermined thick paper, inkjet paper, or the like.

Thus, an unnecessary setting item other than a setting item for “postcard” and “photo” is not displayed, and further, only a necessary setting screen is displayed based on the selection result by a user on the sheet setting screen, and thus, it is possible to perform the sheet setting more efficiently than conventionally, reduce the complexity of the sheet setting, and achieve the digital multifunctional apparatus 1 having high usability for a user.

### Fourth Embodiment

In a fourth embodiment, an application of a user may be estimated based on the automatically detected sheet size and the selection result by the user on the sheet setting screen, and the setting items may be arbitrarily rearranged based on the estimation result.

For example, if “t nick paper” is selected for the sheet type, a setting for “postcard” or “photo” may be preferentially displayed at the top of the setting screen.

Thus, an optimal setting screen is displayed based on the selection result by the user on the sheet setting screen, and thus, it is possible to perform the sheet setting more efficiently than conventionally, reduce the complexity of the sheet setting, and achieve the digital multifunctional apparatus 1 having high usability for a user.

### Fifth Embodiment

In a fifth embodiment, only a setting item for a sheet that can be accommodated in the sheet feed tray selected on the setting screen may be displayed on the setting screen.

For example, if a sheet feed tray that accommodates only “plain paper” is selected, only a setting item for “plain paper” is displayed on the setting screen, and a setting item for other sheets such as “thick paper” is not displayed.

Thus, an optimal setting screen is displayed based on a selection result of the sheet feed tray by a user on the sheet setting screen, and thus, it is possible to perform the sheet setting more efficiently than conventionally, reduce the complexity of the sheet setting, and achieve the digital multifunctional apparatus 1 having high usability for a user.

Preferred aspects of the present invention include combinations of any aspects among the above-described plurality of aspects.

In addition to the above-described embodiments, various modifications in the present invention are possible. These modifications should not be interpreted as not belonging to the scope of the present invention. The present invention should include a meaning equivalent to the claims and all modifications within the scope.

### DESCRIPTION OF REFERENCE NUMERALS

1: Digital multifunctional apparatus,
10: Controller,
11: Scanner,
12: Image former,
13: Memory,
14: Image processing device,
15: Sheet conveyor,
16: Operation panel,
17: Sheet detection sensor,
18: Sheet size detection sensor,
101: Sheet size/type confirmer,
102: Sheet size changer,
120: Output controller,
121: Developer,
122: Transferer,
123: Fixer,
161: Display operation device,
162: Physical operation device

What is claimed is:

1. An image forming apparatus, comprising:
a sheet feed tray that stores a plurality of kinds of sheet for image formation;
a display;
an operation device that receives an operation from a user;
an image former that forms an image; and
a controller that controls the display, the operation device, and the image former, wherein
the controller causes the display to selectably display a plurality of prescribed classifications of the sheet, causes the display to selectably display a kind of sheet included in one classification selected though the operation device, and causes the image former to form an image on one kind of sheet selected though the operation device.

2. The image forming apparatus according to claim 1, wherein
the sheet classifications include prescribed sheet type classifications, and
if the operation device receives an operation that one of the sheet type classifications is selected, the controller causes the display to selectably display a kind of sheet included in the one classification selected though the operation device.

3. The image forming apparatus according to claim 1, wherein
the sheet classifications include prescribed sheet size classifications, and
if the operation device receives an operation that one of the sheet size classifications is selected, the controller causes the display to selectably display a kind of sheet included in the one classification selected though the operation device.

4. The image forming apparatus according to claim 1, further comprising:
a sheet detection sensor that detects whether a sheet is stored in the sheet feed tray, wherein
if the sheet detection sensor detects a sheet stored in the sheet feed tray, the controller causes the display to selectably display a kind of sheet that can be accommodated in the sheet feed tray.

5. The image forming apparatus according to claim 1, further comprising:
a sheet size detection sensor that detects a size of a sheet stored in the sheet feed tray, wherein
the controller causes the display to selectably display a kind of sheet determined to be displayed based on a sheet size detected by the sheet size detection sensor.

6. The image forming apparatus according to claim 1, wherein
the controller causes the display to selectably display, in accordance with a prescribed priority order, a kind of sheet determined to be displayed based on a selection result of the sheet classifications received through the operation device.

7. The image forming apparatus according to claim 1, wherein
the sheet feed tray stores an envelope or a postcard.

8. A method of forming an image by an image forming apparatus including a sheet feed tray that stores a plurality of kinds of sheet for image formation and an image former that forms an image, the method comprising:
displaying;
receiving an operation from a user; and
forming an image, wherein
in the displaying, prescribed classifications of the sheet are selectably displayed, a kind of sheet included in one classification selected in the receiving is selectably displayed, and in the forming, an image is formed on one kind of sheet selected in the receiving.
